(19) United States
(12) Patent Application Publication
(10) Pub. No.: US 2010/0054936 A1
(43) Pub. Date: Mar. 4, 2010

(54) VERTICAL AXIS WIND TURBINE

(76) Inventor: Charles P. Sneeringer, Anacortes, WA (US)

Correspondence Address: THE OLLILA LAW GROUP LLC, 2060 BROADWAY, SUITE 300, BOULDER, CO, 80302, US

(21) Appl. No.: 12/545,929

(22) Filed: Aug. 24, 2009

Related U.S. Application Data
(60) Provisional application No. 61/092,107, filed on Aug. 27, 2008.

(51) Int. Cl. F03D 3/06; F03D 11/00

(52) U.S. Cl. 416/1; 416/210 R; 416/119

(57) ABSTRACT

A vertical axis wind turbine (100) is provided according to an embodiment of the invention. The vertical axis wind turbine (100) comprises a rotatable shaft (101) and one or more arms (102) coupled to and extending from the rotatable shaft (101). The vertical axis wind turbine (100) further comprises one or more blades (103) coupled to the one or more arms (102). A high lift device (210) is coupled to each of the one or more blades (103). The high lift device (210) is adapted to control a lift-to-drag ratio of the blade (103).

### CROSS-REFERENCE TO RELATED APPLICATION

This application claims priority from U.S. Provisional Patent Application No. 61/092,107, filed Aug. 27, 2008, entitled “Vertical Axis Wind Turbine”, the contents of which are incorporated herein by reference.

### TECHNICAL FIELD

The present invention relates to a vertical axis wind turbine, and more particularly, to a vertical axis wind turbine including rotatable blades adapted to optimize the blade's lift-to-drag ratio.

### BACKGROUND OF THE INVENTION

With the increasing costs and decreasing availability of fuels typically used to produce power, wind turbines are being implemented in greater numbers. Wind turbines typically operate by using the kinetic energy of air flow across a propeller to cause the propeller to rotate. The propeller produces electricity using an electric generator.

Wind turbines typically fall into two categories, horizontal-axis wind turbines (HAWTs) and vertical-axis wind turbines (VAWTs). As the name implies, the shaft of the HAWTs are oriented horizontally and downstream from the blades. HAWTs have received great success; however, they suffer from a number of drawbacks. The HAWTs must be mounted at the top of a tower along with the electrical generator. Therefore, their height makes them difficult to install and maintain and makes them visible from great distances, which often causes local resistance to their installation. In addition, the blades of the HAWT must be pointed in the wind stream to operate effectively. Therefore, many HAWT require either an additional vein or a mechanical controller to reposition the orientation of the blades. Typically, the blades are very large and thus, repositioning the blade orientation can require a significant amount of energy. Furthermore, HAWTs can often suffer from structural failure caused by turbulence because the blades are generally installed upstream from the tower.

VAWTs are arranged with the main rotor shaft vertically oriented. One of the main advantages of the VAWTs is that they do not need to be pointed into the wind to generate power. This provides a great advantage over the HAWTs. In addition to their shaft orientation, VAWTs can be further categorized as those that use drag to produce rotation and those that use lift to produce rotation. One drawback to the use of VAWTs in the past is that the drag created when the blades rotate into the wind can be excessive and thus, reduce the power output of the turbine. Prior art approaches, such as the approach disclosed in U.S. Pat. No. 7,385,302 have attempted to overcome the drawbacks associated with VAWTs by allowing the turbine blades to rotate in an orientation such that a portion of the drag is used to rotate the shaft. Although this reliance on drag may produce a higher torque, it lowers the power output by making the shaft rotate at a speed that is less than or equal to the wind speed.

The present invention provides a VAWT that optimizes the lift-to-drag ratio by allowing the blades to pivot so that the blade will assume the most efficient angle of attack at each point as the blades rotate about the shaft. The angle of attack can be controlled by placing the pivot point at the blade's neutral point and using high lift devices coupled to the blades to generate lift.

### SUMMARY OF THE INVENTION

A vertical axis wind turbine is provided according to an embodiment of the invention. The vertical axis wind turbine comprises a rotatable shaft and one or more arms coupled to and extending from the rotatable shaft. The vertical axis wind turbine further comprises one or more blades coupled to the one or more arms. One or more high lift devices are coupled to each of the one or more blades. The high lift devices are adapted to generate lift in a desired direction.

A vertical axis wind turbine is provided according to an embodiment of the invention. The vertical axis wind turbine comprises a rotatable shaft and one or more arms coupled to and extending from the rotatable shaft. One or more blades are coupled to the one or more arms at a neutral point of the blade such that the blade may freely rotate to achieve an angle of attack associated with a desired lift-to-drag ratio.

A method for operating a vertical axis wind turbine is provided according to an embodiment of the invention. The vertical axis wind turbine includes a rotatable shaft, one or more arms coupled to the rotatable shaft, and one or more blades coupled to the one or more arms. The method comprises the steps of determining a desired lift-to-drag ratio for the blades and adjusting one or more high lift device coupled to the one or more blades to generate lift in a desired direction.

### Aspects

Preferably, the one or more blades are rotatably coupled to the one or more arms.

Preferably, the one or more blades are coupled to the arms at a neutral point of the blade such that the blade may freely rotate to assume an angle of attack associated with the desired lift-to-drag ratio of the blade.

Preferably, the vertical axis wind turbine further comprises one or more damping members coupled to the one or more blades.

Preferably, the high lift device is configured to adjust an amount of deflection depending on the angle of the arm with respect to a free wind stream.

Preferably, the vertical axis wind turbine further comprises one or more high lift devices coupled to each of the one or more blades, wherein the high lift devices are adapted to control the desired lift-to-drag ratio of the blade.

Preferably, the vertical axis wind turbine further comprises one or more damping members coupled to the one or more blades.

Preferably, the high lift devices are configured to adjust an angle of deflection depending on the angle of the arm with respect the rotatable shaft.

Preferably, the method further comprises the steps of calculating an angle between a resolved wind velocity vector and a tangential wind velocity vector for the desired lift-to-drag ratio and adjusting the high lift devices based on the angle.

Preferably, the one or more blades are rotatably coupled to the one or more arms.

Preferably, the method further comprises the steps of calculating a neutral pivot point on the blade and coupling the blade to the arm at the neutral pivot point.

### BRIEF DESCRIPTION OF THE DRAWINGS

FIG. 1 shows a vertical axis wind turbine according to an embodiment of the invention.

FIG. 2 shows a top view of the vertical axis wind turbine according to an embodiment of the invention.

FIG. 3 shows wind velocity vectors acting on a blade of the vertical axis wind turbine according to an embodiment of the invention.

FIG. 4 shows various force vectors associated with a blade of the vertical axis wind turbine according to an embodiment of the invention.

FIG. 5 shows a blade of the vertical axis wind turbine according to an embodiment of the invention.

FIG. 6 shows a top view of the vertical axis wind turbine according to an embodiment of the invention.

FIG. 7 shows a sample calculation used to determine unknown values and to optimize power output according to an embodiment of the invention.

### DETAILED DESCRIPTION OF THE INVENTION

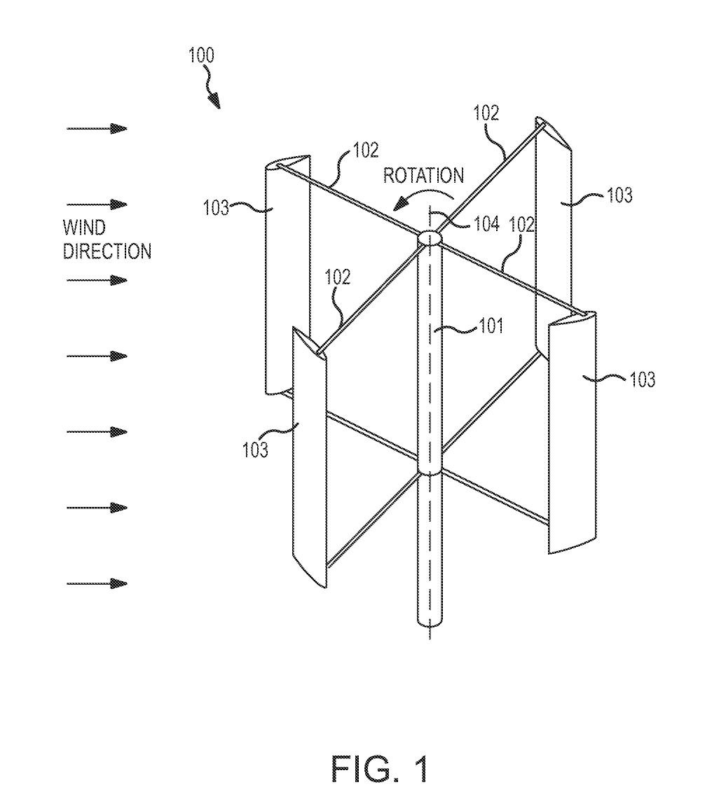

FIGS. 1-7 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a portion of a vertical axis wind turbine 100 according to an embodiment of the invention. It should be appreciated that the electrical generator of the VAWT 100 is not shown for the purpose of clarity. The electrical generator used may comprise any suitable electrical generator as is known in the art. The VAWT 100 comprises a rotatable shaft 101, one or more arms 102, and one or more blades 103 coupled to the arms 102. As shown, according to an embodiment of the invention, the blades 103 extend in a direction parallel to the rotatable shaft 101. Although four arms 102 and four blades 103 are shown, it should be understood that any number of arms 102 and blades 103 could be provided. Therefore, the specific numbers shown in the present application should not limit the scope of the invention.

According to an embodiment of the invention, the shaft 101 rotates about a vertical axis 104. According to an embodiment of the invention, the vertical axis of rotation 104 may comprise an axis perpendicular to the ground or surface to which the shaft 101 is mounted. The shaft 101 can rotate in response to kinetic energy in the form of wind acting on the blades 103. The rotating shaft 101 which can be connected to an electrical generator, can produce electricity as is known in the art.

According to an embodiment of the invention, the blades 103 comprise symmetrically shaped airfoils. According to another embodiment of the invention, the blades 103 comprise symmetric airfoils with a “tear drop” cross sectional shape. The tear drop cross sectional shape is particularly advantageous as it minimizes drag. This is useful in embodiments where the blades 103 are rotated using lift rather than drag as excessive drag may impede the efficiency of the wind turbine 100. It should be understood that the blades 103 may comprise a cross sectional shape other than a tear drop that is designed to minimize drag. According to an embodiment of the invention, the blades 103 are rotatably coupled to the arms 102, such that the blades 103 may rotate freely about an axis parallel to the shaft's axis of rotation 104. The blades 103 may be coupled to the arms 102 by any manner of hinge, pin, bearing member, etc. According to another embodiment of the invention, the blades 103 may be fixedly attached to the arms 102. However, fixedly attaching the blades 103 can seriously reduce the efficiency of the VAWT 100 as discussed below.

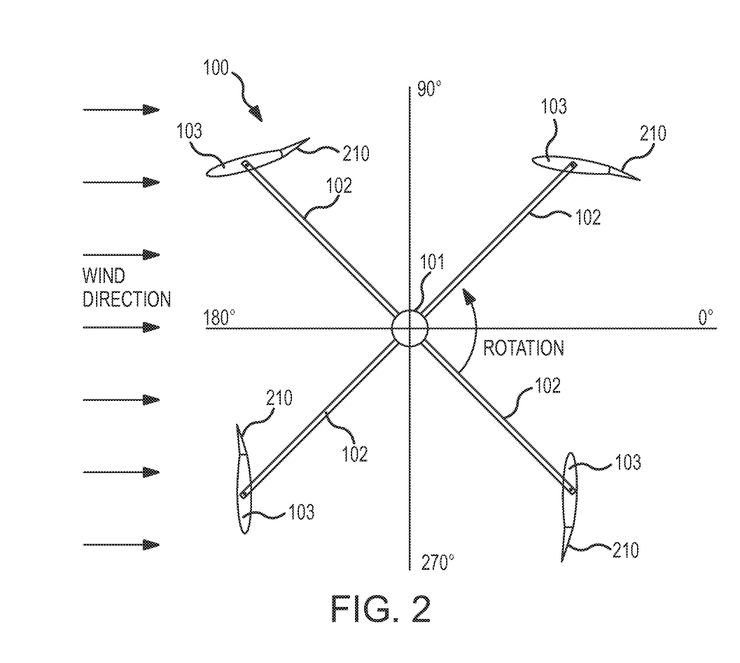

FIG. 2 shows a top view of the VAWT 100 according to an embodiment of the invention. In addition to the components shown in FIG. 1, each of the blades 103 shown in FIG. 2 includes a high lift device 210. Although the high lift device 210 shown in FIG. 2 comprises a plain flap, it should be understood that the high lift device 210 does not have to comprise a plain flap, but rather the high lift device 210 could comprise any well known high lift device 210, or a combination thereof, such as split flaps, slotted flaps, leading edge slats, etc. The particular high lift device 210 or combination of high lift devices 210 should not limit the scope of the present invention; however, the description below is limited to discussing plain flaps solely for the purpose of clarity. According to an embodiment of the invention, the high lift device 210 can be included on the blades 103 in order to add camber to the blade 103. By controlling the camber of the blade 103, the high lift device 210 can cause the blade 103 to produce lift in a desired direction. Coupling the blade 103 at a neutral point, where the pitching moment is approximately zero, causes the blade 103 to produce lift without having to be held at a specific angle of attack. This is in contrast to the prior art methods without high lift devices that require the blade's angle of attack to be mechanically increased in order to increase lift. A problem with the prior art approach is that the blades may reach a critical angle of attack causing the flow to separate from the blade, causing the blade to “stall”, thereby increasing the drag. In contrast, in the present invention, the blade 103 is allowed to pivot, thereby preventing stalling by allowing the blade 103 to maintain the angle of attack corresponding to the optimum lift-to-drag ratio.

According to an embodiment of the invention, the high lift device 210 is mechanically controlled. The deflection of the high lift device 210 may be controlled by a micro-controller (not shown), for example. Other means of controlling the high lift device 210 are contemplated and the specific method for controlling the high lift device 210 should not limit the scope of the invention. According to an embodiment of the invention, the high lift devices 210 are controlled such that the high lift devices 210 coupled to the blades 103 on the upstream side are oriented in a direction opposite from the high lift devices 210 coupled to the blades 103 on the downstream side. This can be seen in FIG. 2 where the high lift devices 210 associated with the blades 103 on the down stream side of the shaft 101 are directed towards the center of the VAWT 100, while the high lift devices 210 associated with the blades 103 on the upstream side of the shaft 101 are directed out away from the center of the VAWT 100. Therefore, as the wind rotates the arms 102 and blades 103 about the vertical axis 104, the angle of deflection of the high lift devices 210 can be repositioned in order to maintain an optimum lift-to-drag ratio and rotation in the proper direction. According to an embodiment of the invention, the high lift device 210 may be adjusted to a single angle of deflection regardless of the wind speed and direction. According to another embodiment, the VAWT 100 may include a sensor (not shown) that can calculate various wind characteristics. Based on the measured wind characteristics, the angle of deflection of the high lift device 210 can be adjusted accordingly. Therefore, the blades 103 can maintain a high lift-to-drag ratio in substantially all positions throughout rotation of the shaft 101. The optimum lift-to-drag ratio may depend on the specific blades 103 and high lift devices 210. Therefore, the optimum lift-to-drag ratio may vary from one VAWT 100 to another. However, once an optimum lift-to-drag ratio is determined, the high lift devices 210 may be used to maintain the ratio throughout the rotation of the VAWT 100.

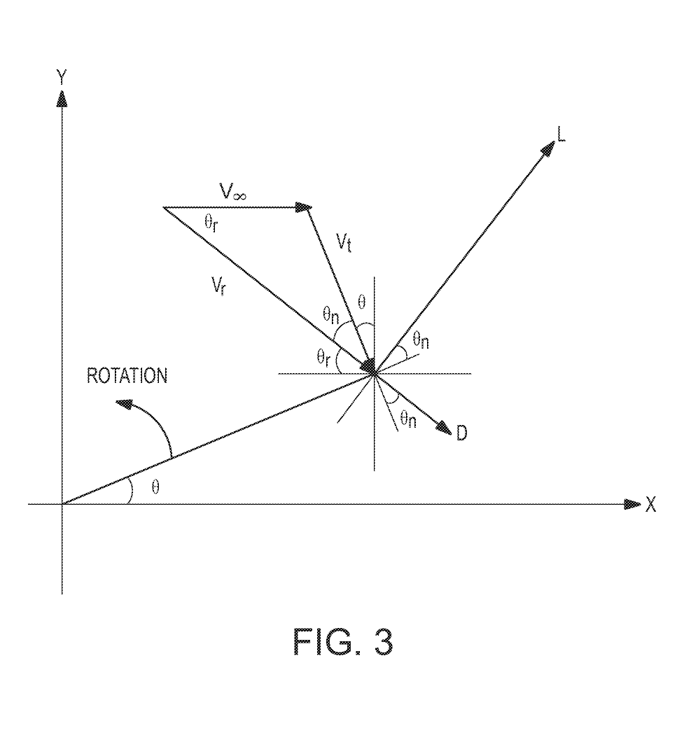

FIG. 3 shows the various forces that are applied to the VAWT 100 and more specifically, the various forces acting on the blades 103 as they rotate about the axis 104. The figure depicts the forces acting on the upper right blade 103 as shown in FIG. 2. It should be appreciated that the remaining blades will experience similar forces and only one of the blade forces is shown in the interests of brevity.

As shown, three wind velocity vectors are shown in FIG. 3. V_{∞} comprises the wind upstream from the blade at an infinite distance away from the blade 103. The second wind velocity vector comprises Vₜ, which is the tangential component of the wind acting on the blade 103 due to the blade rotation. According to an embodiment of the invention, the magnitude of Vₜ is equal to the length of the arm 102 holding the blade 103 multiplied by the angular velocity of the arm 102 in radians/second. The third velocity vector is the resolved velocity vector, Vᵣ. This is the velocity that is actually experienced by the blade 103. Although V_{∞} remains constant for a given wind velocity, Vₜ and Vᵣ change continuously in direction with rotation and Vᵣ also changes in magnitude with rotation.

There are also three angles shown in FIG. 3, θ, θᵣ, and θₙ. θ comprises the angle between the arm 102 and the wind stream at an infinite distance V_{∞}, which is parallel to the X-axis as shown in FIG. 3. θᵣ is the angle between the resolved velocity vector, Vᵣ, and the wind stream at an infinite distance, V_{∞}. The last angle θₙ, comprises the angle between the resolved velocity vector, Vᵣ, and the tangential velocity vector, Vₜ.

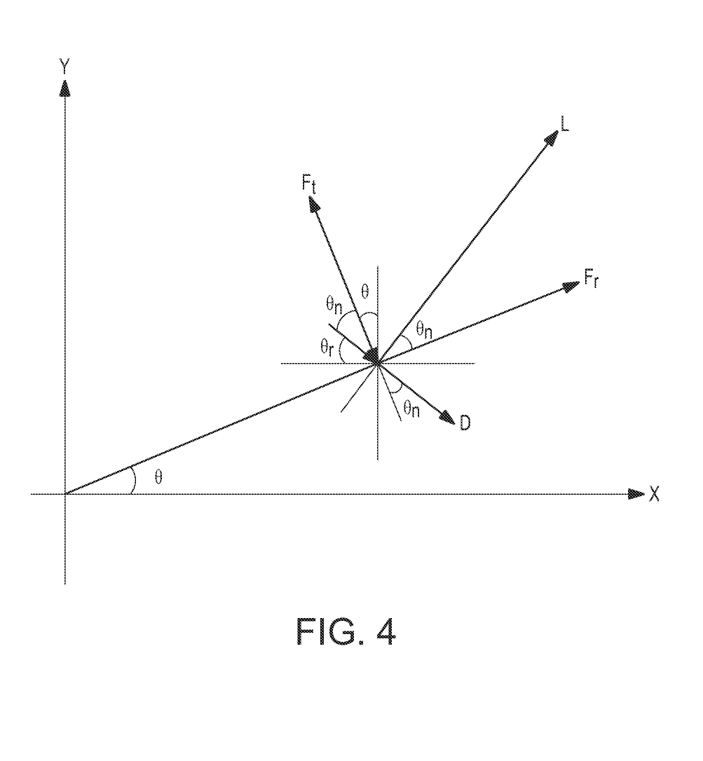

As mentioned above, in order to maintain rotation of the blades 103, L*sin θₙ should be greater than D*Cos θₙ, or in other words, the lift-to-drag ratio should be greater than Cot θₙ averaged over one revolution. In order to maintain rotation, the high lift device 210 should be deflected in opposite directions on the upstream side and the downstream side of the shaft 101. On the right side of the Y-axis, the resolved velocity vector, Vᵣ, will be on the inboard side of the tangential velocity vector, Vₜ, designated positive θₙ, while on the left side of the Y-axis, the resolved velocity vector, Vᵣ, will be on the outboard side of the tangential velocity vector, Vₜ, designated negative θₙ. When θₙ is positive, the high lift device 210 should be deflected in an inward direction producing lift that causes the blade 103 to travel in the positive Y-direction. Conversely, when θₙ is negative, the high lift device 210 should be deflected in the outward direction, producing a lift that causes the blade 103 to travel in the negative Y-direction. This maintains a counter-clockwise rotation of the arms 102 about the vertical shaft 101. It should be appreciated that deflecting the high lift device 210 in the opposite direction causes the arms 102 to rotate in a clockwise direction. According to an embodiment of the invention, the high lift devices 210 are provided to maintain the desired rotation as described in more detail below. With an understanding of the wind velocity vectors, attention is turned to FIG. 4 and the accompanying description for an explanation of the forces that result from the applied wind velocity vectors.

FIG. 4 shows a force diagram of the lift, drag, tangential force, and radial force vectors. The wind components have been removed for clarity. From FIG. 4, the following relationships can be derived:

Fₜ=L sin θₙ−D cos θₙ (1)

Fᵣ=L cos θₙ+D sin θₙ (2)

90°=θ+θₙ+θᵣ (3)

Where:
Fₜ=tangential force
Fᵣ=radial force
L=Lift
D=Drag

Additionally, by FIG. 3, it can be appreciated that:

Sin θᵣ=(Vₜ/Vᵣ)cos θ (4)

Cos θᵣ=((V_{∞}+Vₜ)Sin θ)/Vᵣ (5)

Using trigonometric identities for Sin(A+B) and Cos(A+B) along with equations 3-5, the following relationships can be derived:

Sin θₙ=(V_{∞}/Vᵣ)Cos θ (6)

Cos θₙ=(Vₜ+V_{∞} Sin θ)/Vᵣ (7)

In addition, from general aerodynamic theory:

L=C_{L}½ρV²S (8)

D=C_{D}½ρV²S (9)

Where:
C_{L}=coefficient of lift
C_{D}=coefficient of drag
ρ=density of air
V velocity of wind, in this case Vᵣ
S the area of the blade

All of the variables mentioned above may be calculated, measured in the field, or obtained from lookup tables, for example.

Substituting equations 6-9 into equations 1 & 2 gives:

Fₜ=½ρVᵣS(C_{L}V_{∞} Cos θ−C_{D}(Vₜ+V_{∞} Sin θ)) (10)

Fᵣ=½ρVᵣS(C_{L}(V_{∞}+Vₜ sin θ)+C_{D}V_{∞} Cos θ) (11)

Therefore, the tangential and radial force vectors can be described in terms of the wind characteristics as experienced by the blades 103.

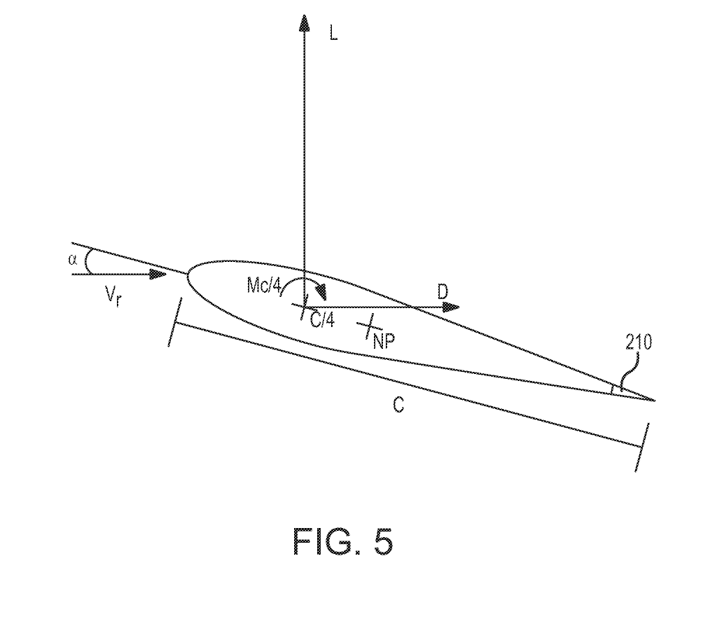

FIG. 5 shows a blade 103 according to an embodiment of the invention. Also shown in FIG. 5 are the lift, L; drag, D; pitching moment, M; the resolved wind velocity vector, Vᵣ; and the angle of attack, α. The angle of attack, α, comprises the angle between the chord line of the blade 103 and the resolved wind velocity vector, Vᵣ. The chord length, C, is shown to be the length of the blade 103 without the high lift device 210 deflected. A neutral point, NP, is shown aft of the quarter chord point, C/4. According to an embodiment of the invention, for a symmetrically shaped blade 103 as shown in FIG. 5, if a high lift device 210 is deflected in a first direction, the pitching moment, M, will be negative, that is, opposite of the direction shown in FIG. 5. Conversely, if the high lift device 210 is deflected in a second direction, the pitching moment, M, will be in the direction shown but the lift will be in the opposite direction.

According to an embodiment of the invention, the blade 103 is coupled to the arm 102 at the neutral point, NP. The neutral point, NP, is defined as the point where the blade's pitching moment, M, is approximately zero. For a symmetrically shaped blade 103 without a high lift device 210, the neutral point will generally be at the quarter chord point, C/4. However, for a symmetrically shaped blade 103 with the high lift device 210 deflected, the neutral point, NP, will be aft of the quarter chord point, C/4. According to an embodiment of the invention, the neutral point's location will be a function of the angle of attack, α, for a given blade 103 having an actuated high lift device 210.

According to an embodiment of the invention, to determine the location of the neutral point, NP, the moments about a point on the blade 103 are summed and set equal to zero. According to one embodiment of the invention, the point on the blade 103 can be the leading edge, for example. A resultant vector equal to the magnitude of the lift, L, and in the opposite direction is placed at the neutral point, NP, and the angle of attack, α, is assumed to be small so that Sin α is approximately equal to zero and Cos α is approximately equal to 1. Based on these assumptions, the following equation can be derived:

Σ M_{LE}=0=M_{C/4}−0.25 C*L+X_{NP}*L (12)

Where:

M_{C/4}=C_{MC/4}½ρV²SC (13)
C_{MC/4}=pitching moment coefficient

Combining equations 12 & 13 gives:

0=½ρV²S(C*C_{MC/4}−0.25 C*C_{L}+X_{NP}*C_{L}) (14)

Equation 14 can be rearranged to solve for X_{NP} giving:

X_{NP}=C(0.25*C_{L}−C_{MC/4})/C_{L} (15)

Equation 15 can be solved with data for the particular airfoil used for the blade 103 at the angle of attack, α, that has the optimum lift-to-drag ratio. For example, if the coefficient of lift, C_{L}, at the optimum lift-to-drag ratio is approximately 1.0 and the pitching moment coefficient, C_{MC/4}, is approximately −0.1, both of which are reasonable, the neutral point will be at 0.35 C or at 35% of the chord. The optimal location of the neutral point, NP, can be further determined with field testing since the equation derived above only gives an approximate location. According to an embodiment of the invention, this is where the blade 103 is coupled to the arm 102. In other words, the blade 103 can be coupled to the arm 102 such that the blade 103 is able to freely rotate and align itself at an angle of attack such that the lift-to-drag ratio is maximized. The blade 103 can rotate as Vᵣ changes direction as the arm 102 rotates about the vertical axis 104 when the high lift device 210 is deflected by a predetermined amount. It should be understood that the neutral point, NP, will depend on the particular values used in the above equations and therefore may vary from the calculated position described above. The values used may vary for any number of reasons and therefore, the particular values should be based on the specific blades and conditions experienced in the environment. Therefore, the present invention should not be limited to the values provided above as these are merely examples used to aid in the understanding of the invention. In addition, as mentioned above, the optimum lift-to-drag ratio may vary from one combination of blade and high lift device to another. Therefore, the optimum lift-to-drag ratio should not limit the scope of the invention.

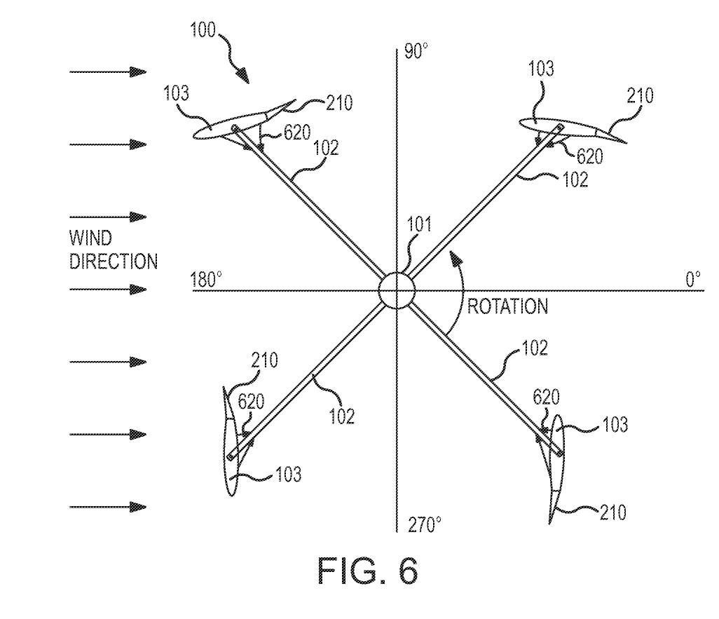

FIG. 6 shows a top view of the VAWT 100 according to another embodiment of the invention. According to an embodiment of the invention, the VAWT 100 further comprises a damping member 620 coupled between the arm 102 and the blade 103. The damping member 620 may be provided to reduce rapid fluctuations or vibrations caused by turbulence or other flow instabilities that may be present. The damping member 620 may comprise a variety of well known damping devices such as a frictional, fluid powered, or mechanical damping device such as a spring or other biasing member, for example. The particular damping member may depend on anticipated wind conditions at the site location. Therefore, a user or operator of the VAWT 100 can choose the damping device to accommodate the particular situation.

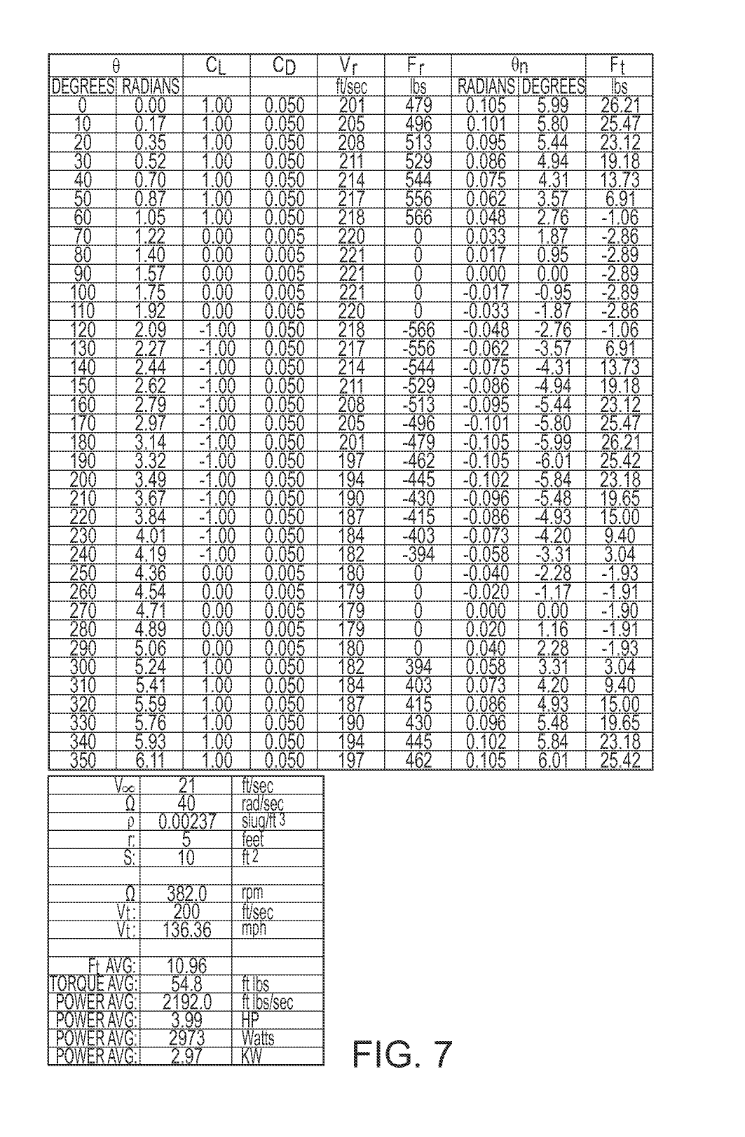

FIG. 7 shows example calculations performed to determine several unknowns according to an embodiment of the invention. It should be understood that the table shown is merely one example and the particular numbers used and calculated should not limit the scope of the invention. Rather, the table is provided as an example to show the calculation of unknown quantities that can be anticipated as a blade 103 rotates through a 360° circle, with 0°/360° parallel to the infinite wind velocity, V_{∞}. By determining the unknown quantities for a given set of input conditions, adjustments are made to the values of the lift and drag coefficients which represent different high lift device deflections and power output is maximized

As can be seen, when θ is between approximately 0° and 60° and again between approximately 300° and 350°, C_{L} is assigned a value of 1.00 and C_{D} is assigned a value of 0.05. These values result in a lift-to-drag ratio of 20:1. Again, the particular values used may vary and may require in the field testing for determining the precise values corresponding to the particular VAWT 100. When θ is between approximately 120° and 240°, θₙ is negative and C_{L} is assigned the value of approximately −1.00 according to the discussion above and C_{D} is assigned a value of 0.05. When θ is around 90° and 270°, C_{L} is given the value 0.00 and C_{D} is given a value of 0.005. According to an embodiment of the invention, the high lift device 210 is not deflected during this period.

Using the values mentioned above and shown in FIG. 7 along with the coordinates as shown in FIG. 2, it was found that to optimize F_{Tavg.}, the high lift device 210 should not be deflected when −2.5°<θₙ<2.5°. In other words, a negative effect may be realized if the high lift device 210 is deflected when θ is close to approximately 90° and 270°. Therefore, it can be seen that starting from 0°, the high lift device 210 is deflected towards the center of the VAWT 100, which increases lift in the positive Y-direction. As the blade 103 rotates about the vertical axis 104 and approaches 70° the high lift device 210 should straighten out. Once the blade 103 reaches approximately 120°, the high lift device 210 deflects outward; the outward deflection causes lift in the negative Y-direction. Once the blade 103 reaches approximately 250°, the high lift device 210 straightens out. Once the blade 103 reaches approximately 300°, the high lift device 210 again deflects inwards until approximately 70° again causing lift in the positive Y-direction. As the high lift device 210 deflects, the blade 103 can pivot about the neutral point NP to assume the angle of attack required to meet the desired lift-to-drag ratio. According to an embodiment of the invention, the desired lift-to-drag ratio may comprise the optimum lift-to-drag ratio. Thus, the high lift device 210 can be actuated depending on the desired lift direction.

The embodiments described above provide a vertical axis wind turbine 100 that is capable of providing an optimum lift-to-drag ratio regardless of the blade orientation with respect to a rotatable shaft 101. Unlike prior art VAWTs, which rely upon external veins, which sense the wind at an infinite distance from the blades, to operate, the VAWT 100 of the present invention operates using lift and allows the blades 103 to orient themselves based on flow conditions at the point of rotation and the wind actually sensed by the blades 103. Each of the blades 103 can be provided with a high lift device 210 adapted to increase the lift of the blade 103. By adjusting the angle of deflection of the high lift device 210, the blade 103 can be configured such that lift is generated in the proper direction based on knowing the sign and magnitude of θₙ. Therefore, the blade 103 does not require an external vein, which orients the blades 103 based on V_{∞}, as required in the prior art. Rather, the blade 103 pivots based on Vᵣ, the wind the blade experiences which changes from point to point in the rotation.

In addition, the VAWT 100 of the present invention couples the blades 103 to the arms 102 at a position that allows the blades 103 to freely rotate. This neutral point, NP, is chosen such that the moment at the pivot point is approximately zero. The neutral point, NP, can be chosen based on an optimum lift-to-drag ratio. This is in contrast to the prior art design which chooses the pivot point of the blades at an arbitrary position.

Another advantage of the present invention is the shape of the blades 103. The shape of the blades 103 are chosen such that drag is minimized. According to an embodiment of the invention, the blades 103 comprise a symmetrical tear drop cross sectional shape. The tear drop shape reduces drag as wind flows around the blades 103. Therefore, the efficiency of the turbine of the present invention is increased even further.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other wind turbines, and not just to the embodiments described above and shown in the accompanying figures. Accordingly, the scope of the invention should be determined from the following claims.

I claim:

1. A vertical axis wind turbine (100), comprising:
a rotatable shaft (101);
one or more arms (102) coupled to and extending from the rotatable shaft (101);
one or more blades (103) coupled to the one or more arms (102); and
one or more high lift devices (210) coupled to each of the one or more blades (103), wherein the high lift devices (210) are adapted to generate lift in a desired direction.

2. The vertical axis wind turbine (100) of claim 1, wherein the one or more blades (103) are rotatably coupled to the one or more arms (102).

3. The vertical axis wind turbine (100) of claim 1, wherein the one or more blades (103) are coupled to the arms (102) at a neutral point of the blade (103) such that the blade (103) may freely rotate to assume an angle of attack (a) associated with a desired lift-to-drag ratio of the blade (103).

4. The vertical axis wind turbine (100) of claim 1, further comprising one or more damping members (620) coupled to the one or more blades (103).

5. The vertical axis wind turbine (100) of claim 1, wherein the high lift devices (210) are configured to adjust an amount of deflection depending on the angle (θ) of the arm (102) with respect to a free wind stream V_{∞}.

6. A vertical axis wind turbine (100), comprising:
a rotatable shaft (101);
one or more arms (102) coupled to and extending from the rotatable shaft (101); and
one or more blades (103) coupled to the one or more arms (102) at a neutral point (NP) of the blade, such that the blade (103) may freely rotate to achieve an angle of attack (α) associated with a desired lift-to-drag ratio of the blade (103).

7. The vertical axis wind turbine (100) of claim 6, further comprising one or more high lift devices (210) coupled to each of the one or more blades (103), wherein the high lift devices (210) are adapted to generate lift in a desired direction.

8. The vertical axis wind turbine (100) of claim 6, further comprising one or more damping members (620) coupled to the one or more blades (103).

9. The vertical axis wind turbine (100) of claim 6, further comprising one or more high lift devices (210) coupled to each of the one or more blades (103), wherein the high lift device (210) is configured to adjust an angle of deflection depending on the angle (θ) of the arm (102) with respect the rotatable shaft (101).

10. A method for operating a vertical axis wind turbine including a rotatable shaft, one or more arms coupled to the rotatable shaft, and one or more blades coupled to the one or more arms, the method comprising the steps of:
determining a desired lift-to-drag ratio for the one or more blades; and
adjusting one or more high lift devices coupled to the one or more blades to maintain the desired lift-to-drag ratio.

11. The method of claim 10, further comprising the steps of calculating an angle between a resolved wind velocity vector and a tangential wind velocity vector and adjusting the high lift devices for the desired lift-to-drag ratio based on the angle.

12. The method of claim 10, wherein the one or more blades are rotatably coupled to the one or more arms.

13. The method of claim 10, further comprising the steps of calculating a neutral pivot point on the blade and coupling the blade to the arm at the neutral pivot point.
